(19) United States
(12) Patent Application Publication
(10) Pub. No.: US 2004/0068504 A1
(43) Pub. Date: Apr. 8, 2004

(54) Serving apparatus for providing storage solutions

(76) Inventors: Peter Gobbi, Bradford (GB); Ian Heuston, Leeds (GB)

Correspondence Address: HARNESS, DICKEY & PIERCE, P.L.C., P.O. BOX 828, BLOOMFIELD HILLS, MI, 48303, US

(21) Appl. No.: 10/264,821

(22) Filed: Oct. 4, 2002

(51) Int. Cl. G06F 17/00

(52) U.S. Cl. 707/100

(57) ABSTRACT

A server (502) connected to an inter-network receives requests from remote customers (2703) relating to components of storage supporting means, such as pallet racking and shelving etc. Storage requirement input data (2704) is received from remote customers. The server includes a database for storing data related to attributes of components for storage support. Calculations are performed based on data received from customers in combination with data read from the database. Graphical data is supplied to remote customers (2705) for display at a customers terminal in the form of a proposal for a storage solution. Thus, in response to specifying storage requirements, a customer is provided with a solution and a graphical representation thereof.

### BACKGROUND OF THE INVENTION

1. Field of the Invention

The present invention relates to a serving apparatus connected to an inter-network configured to receive request from remote customers over said inter-network relating to components of storage supporting means.

2. Description of the Related Art

For many years items have been stored in warehouses in a fashion that allows the items to be loaded and unloaded using a forklift truck or similar equipment. To facilitate storage of this type, large items would be stored in the form of smaller sub-components whereas small items may be packaged in boxes with the boxes again being loaded onto an appropriate pallet and secured in some fashion. In many warehousing and wholesale environments, such a collection of items is often referred to as a traded unit.

When storing traded units of this type, it is desirable to store them as efficiently as possible within warehousing space. The units are therefore often stored on pallet racking consisting of upright frames and horizontal beams that interlock to form a racking structure. For many products, it will be essential to ensure that each pallet is individually accessible with aisles being provided between racking runs.

The use of specialized removal equipment may allow storage efficiency to be increased from say 40% to 45% by reducing the isle width between racks to around five feet. Alternatively, if storage capacity is the prime requirement, isles and lanes may be eliminated but under such arrangements, the first pallet into a lane will be the last out.

In addition to being provided in a plurality of different racking types, pallet racking is also available at various levels of strength dependant upon the weight of units to be supported. Thus, when presented with a particular type of traded unit, having a specified dimension and weight, a warehouse manager would be required to design pallet racking that optimises the available space in the warehouse, while providing sufficient strength to ensure safety of storage but minimising the risk of over engineering the solution and thereby adding unnecessary cost.

Conventionally, racking suppliers are available to assist with the design process. Often, they will provide a costed solution with drawings showing how the racking would be arranged within the warehouse. A problem with such an approach is that several weeks may pass between an initial consultation and the final provision of a racking solution. Furthermore, from the suppliers perspective, significant work may have been performed in order to provide a solution whereafter the work is effectively lost because the customer does not place an order. Suppliers therefore have significant difficulties in terms of identifying the extent to which racking solutions should be provided to customers, where the cost of employing sales staff etc may add a significant overhead that will also be reflected in the final selling price. Consequently, there is a desire to enhance the speed with which racking solutions may be presented to potential customers, thereby increasing the possibility of a sale being made, while at the same time reducing unnecessary overhead in terms of sales staff who may be asked to provide many potential solutions that do not ultimately lead to a sale being made.

Similar situations arise with respect to the provision of shelving systems, such as large office shelving solutions. However, it is appreciated that shelving systems tend to be limited in terms of the height therefore to some extent the calculations are less complex. Brief Summary of the Invention

According to an aspect of the present invention, there is provided serving apparatus connected to an inter-network configured to receive requests from remote customers over said inter-network relating to components of storage supporting means. The serving apparatus includes input means for receiving storage requirement input data from remote customers. The serving apparatus also includes a database for storing data relating to attributes of components for storage supporting means, processing means for performing calculations based on data received from customers in combination with data read from said database and output means for supplying graphical data to remote customers, wherein said graphical data is displayed at a customers terminal in the form of a proposal for a storage solution. In operation, an identification of storage type in received by the input means. A definition of available storage space is also received by the input means. The processing means calculates a substantially optimum storage configuration and then generates the graphical representation of this storage configuration. The output means supplies the graphical representation of the storage configuration to the customer.

### BRIEF DESCRIPTION OF THE SEVERAL VIEWS OF THE DRAWINGS

FIG. 1 shows a trading unit supported by a pallet;

FIG. 2 illustrates a warehouse facility;

FIG. 3 details the recordal of information relating to a racking problem;

FIG. 4 illustrates equipment for gaining access to the world wide web;

FIG. 5 illustrates computer systems connected to the world wide web;

FIG. 6 details a serving system identified in FIG. 5;

FIG. 7 details a computer system identified in FIG. 6;

FIG. 8 shows procedures performed by the processing unit identified in FIG. 7;

FIG. 9 shows a home page for selecting an environment type;

FIG. 10 shows illustrates a page for selecting a brand type;

FIG. 11 shows illustrates an electronic form for receiving specification information;

FIG. 12 shows an example of a design for a pallet racing structure;

FIG. 13 shows procedures for calculating a solution;

FIG. 14 illustrates an example of a result of a tier calculation;

FIG. 15 illustrates an array derived from a database;

FIG. 16 illustrates calculations for weight determination;

FIG. 17 shows a plan view of a bay;

FIG. 18 illustrates an array derived from the database;

FIG. 19 illustrates procedures for calculating bay width;

FIG. 20 details the process for calculating the number of bays;

FIG. 21 illustrates results produced by the procedure identified in FIG. 13;

FIG. 22 details a process for calculating the number of runs;

FIG. 23 details results obtained by the process identified in FIG. 13.

FIG. 24 details the process identified in FIG. 8 for providing a presentation to the customer.

FIG. 25 details the process identified in FIG. 24 for scaling and drawing a plan view.

FIG. 26 details an HTML page;

FIG. 27 details operations identified in FIG. 8 for responding to an order; and

FIG. 28 illustrates and example of an order and an example of invoice.

### WRITTEN DESCRIPTION OF THE BEST MODE FOR CARRYING OUT THE INVENTION

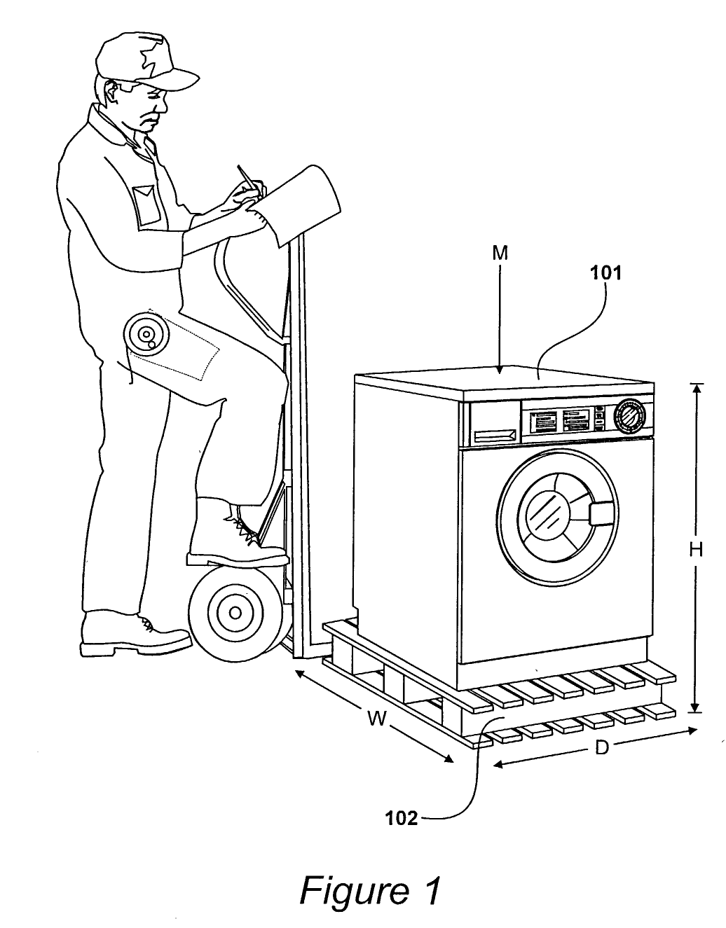

FIG. 1

A warehouse manager is required to design a pallet racking system for storing traded units 101 in an efficient manner. Each traded unit 101 is supported by and attached to a pallet 102 to facilitate transportation within a warehouse facility using a forklift truck. A combination of the traded unit 101 and the pallet 102 will be referred to herein as a stored unit. Many stored units of this type are to be stored in a warehouse facility and each location where a unit may be stored will be referred to herein as a unit space.

A typical stored unit is measured to identify a minimum unit space of width W, depth D and height H. The weight of the stored unit is also identified as mass M.

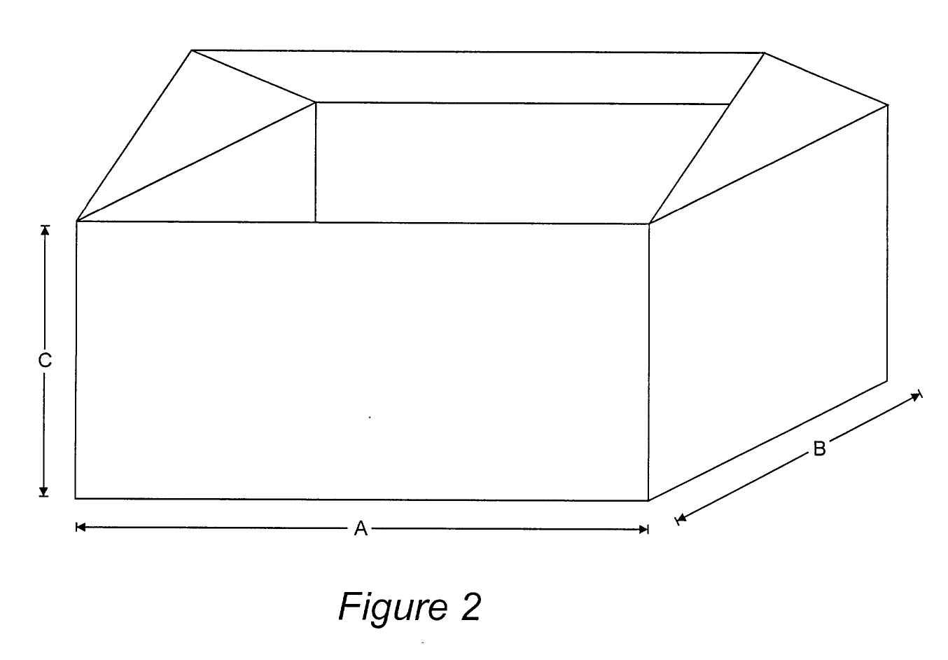

FIG. 2

The warehouse facility has dimensions as illustrated in FIG. 2. The warehouse manger measures the internal space available for the pallet racking to determine that the space has a length A, a width B and a height C.

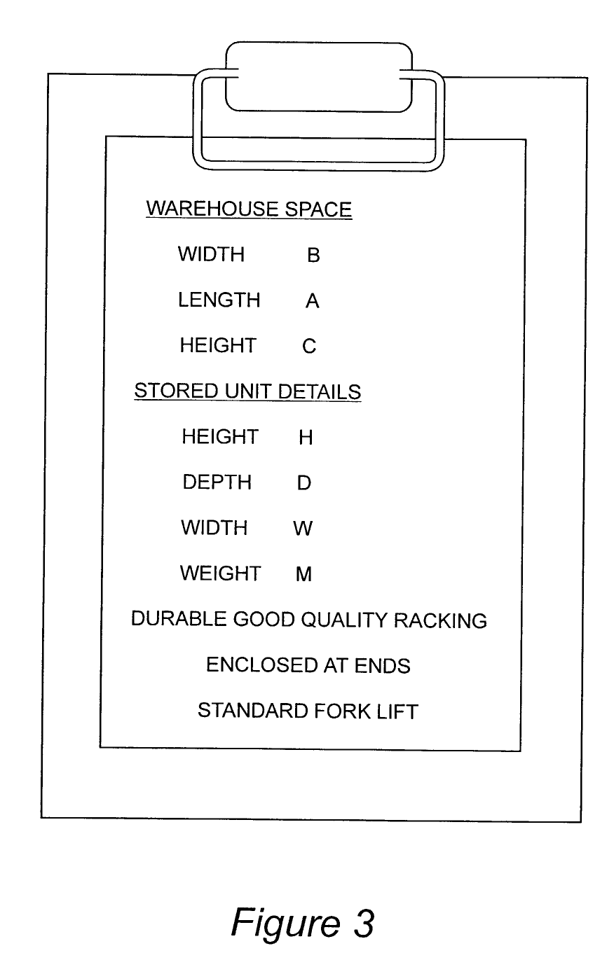

FIG. 3

The warehouse manager records measurements as illustrated in FIG. 3. Thus, the manager notes that the warehouse space has a width B, a length A and a height C. Similarly, the stored unit space has a height H, a depth D, a width W and a weight M. The manager has also noted that durable good quality racking should be used and that it should be enclosed at each end. The manager has also noted that a standard folk lift truck is to be used, which in turn will influence the size of aisles required to gain access.

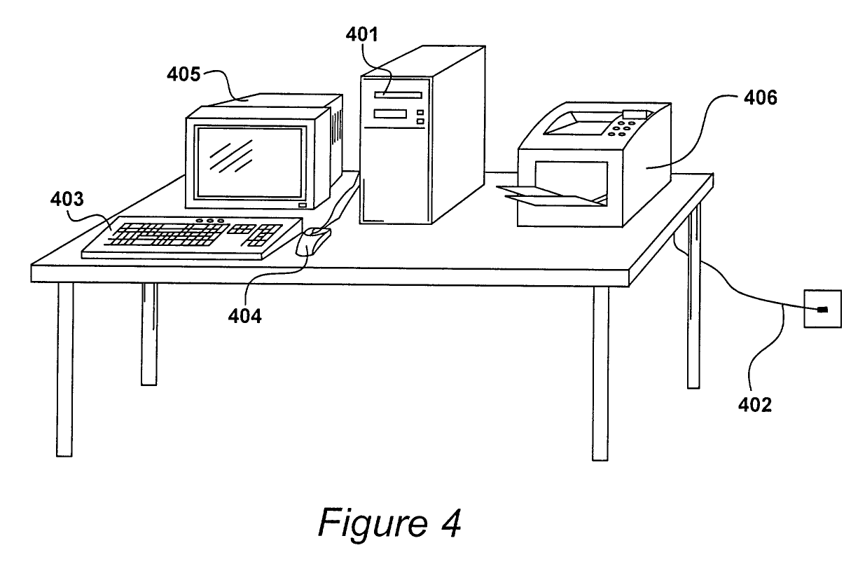

FIG. 4

The warehouse manager has access to the world wide web. A main computer system 401 communicates with the world wide web via a telephone connection 402. The system 401 responds to input commands from a keyboard 403 and a mouse 404 and information is displayed to the warehouse manager via a visual display unit 405. Hard copy output is also obtained via a printer 406.

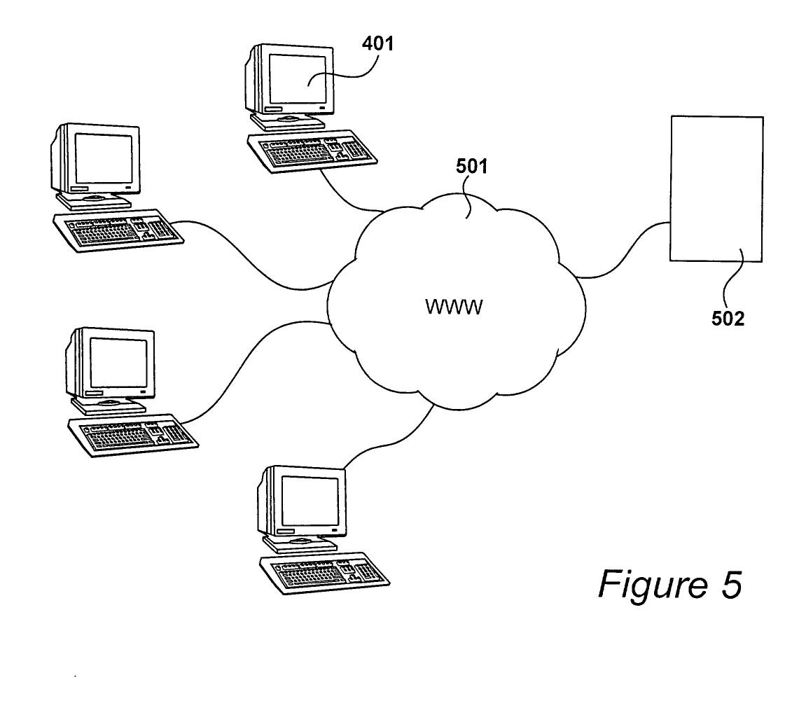

FIG. 5

Computer system 401, along with many other similar systems, is connected to the world wide web 501. The world wide web is a preferred example of an inter-network but in an alternative embodiment the functionality is provided over a private intranet or other network. In the preferred embodiment hyper-text transport protocol is used but in alternative embodiments other transmission protocols and data environments may be used.

Using computer terminal 401, the warehouse manager communicates with a network serving system 502. The serving system 502 (connected to the world wide web 501) receives requests from remote customers 401 relating to components of storage supporting systems such as pallet racking and shelving. At the network serving system, storage requirement input data is received. A database stores data relating to attributes of components for the storage supporting means. Processing means perform calculations based on data received from customers in combination with data read from the database. Output means supply graphical data to remote customers, wherein the graphical data is displayed at the customer's terminal 401 in the form of a proposal for a storage solution. At the network serving system, an identification of storage type is received followed by a definition of the available storage space. Having received this information, a processor calculates a substantially optimum storage configuration and produces a graphical representation of the storage configuration. This graphical representation is then supplied to the customer 401.

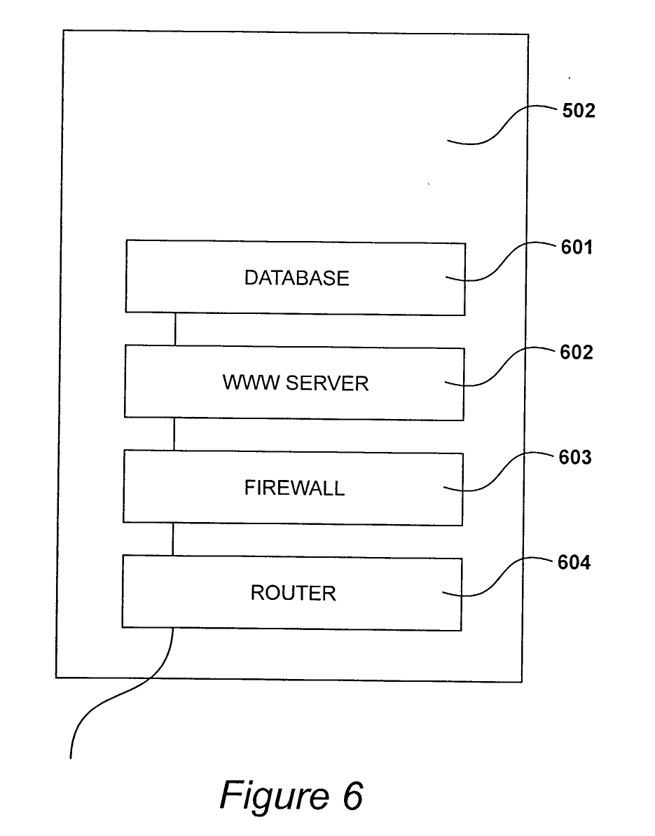

FIG. 6

Network serving system 502 is detailed in FIG. 6. The system includes a plurality of Intel processor based PC platforms running an appropriate operating system such as Linux or Microsoft Windows.

To provide the functionality of the preferred embodiment, a first computer system 601 runs a database application defining a data model of the available racking and storage components.

A second computer system 602 executes a world wide web server in addition to performing the majority of calculations required for the present preferred embodiment, with reference to information received from database 601 in combination with data received from a user.

A third computer system 603 provides a firewall and in turn communicates with a router 604 connected to the Internet.

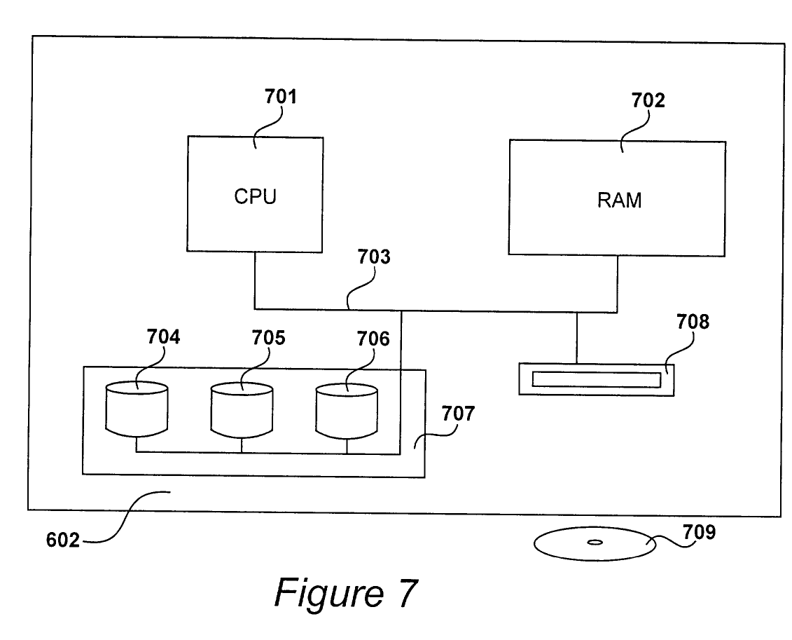

FIG. 7

Computer system 602 is detailed in FIG. 7. A central processing unit 701 communicates with random access memory 702 over an internal system bus 703. Permanent storage is provided by a plurality of disk drives 704, 705 and 706 configured as a redundant array of independent disks (raid) that appear to the CPU 701 as a unified volume 707.

Program instructions are installed on storage volume 701 via a CD ROM drive 708 configured to receive CD ROM 709. CPU 701 receives instructions to facilitate the installation of program instructions received via CD ROM 709, whereafter said instructions may be loaded from storage 707 to RAM 702 for executed on the CPU 701.

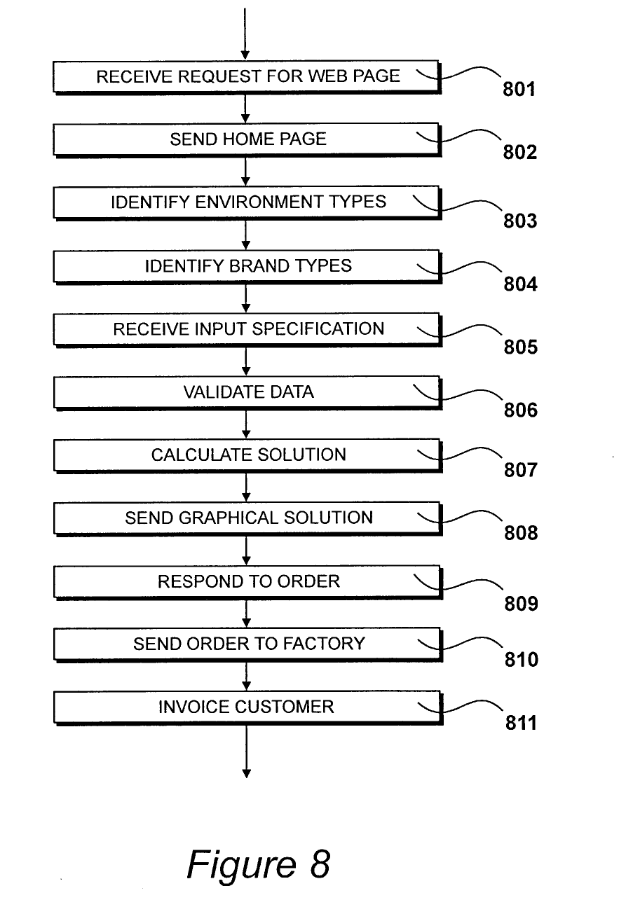

FIG. 8

Procedures performed by CPU 701 under program instructions of the preferred embodiment are identified in FIG. 8.

At 801 the server 602 receives a request for a web page to be supplied; this being the home page of the present preferred embodiment. Consequently, at step 802 the home page is returned to the requesting browser (such as terminal 401) over the world wide web 501.

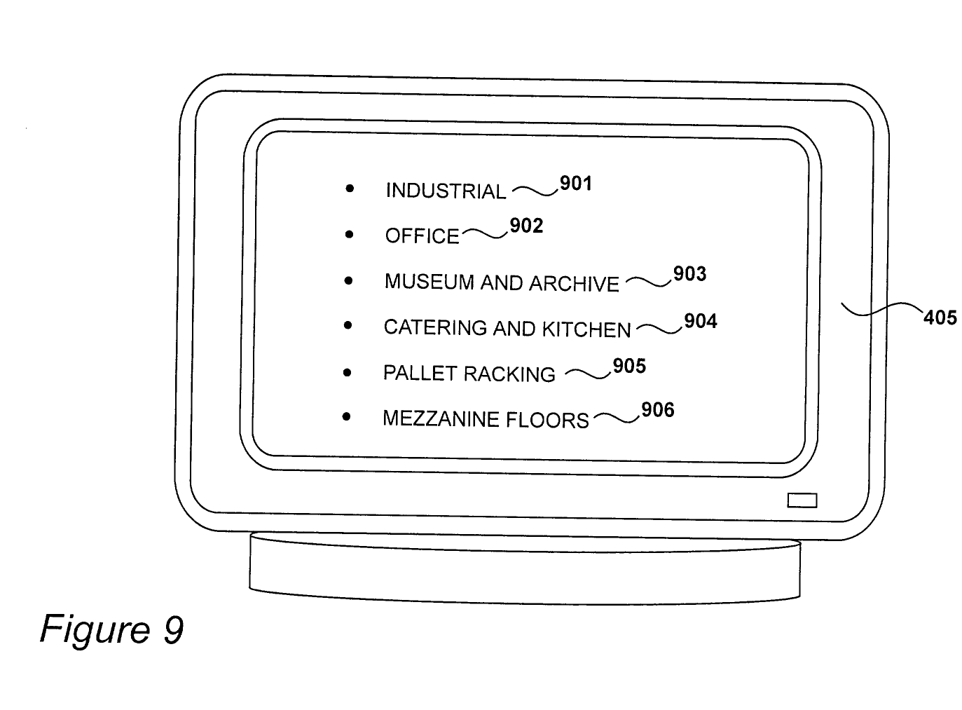

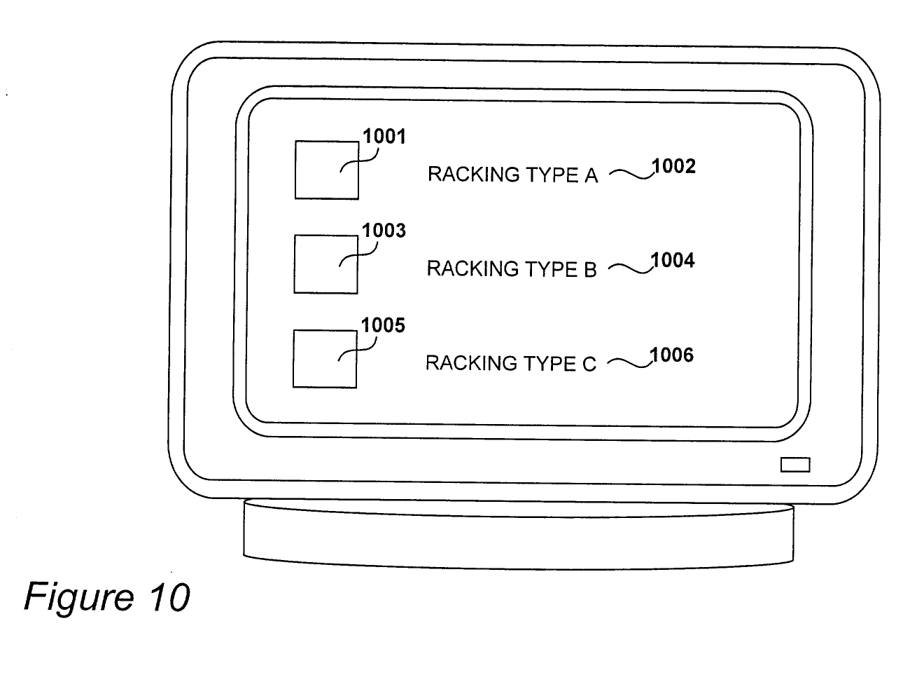

As illustrated at step 803, the home page identifies environment types to the user, displayed on monitor 405, as detailed in FIG. 9. A user specifies a particular environment of interest resulting in a new page being transmitted inviting the user to identify a brand type, as detailed in FIG. 10.

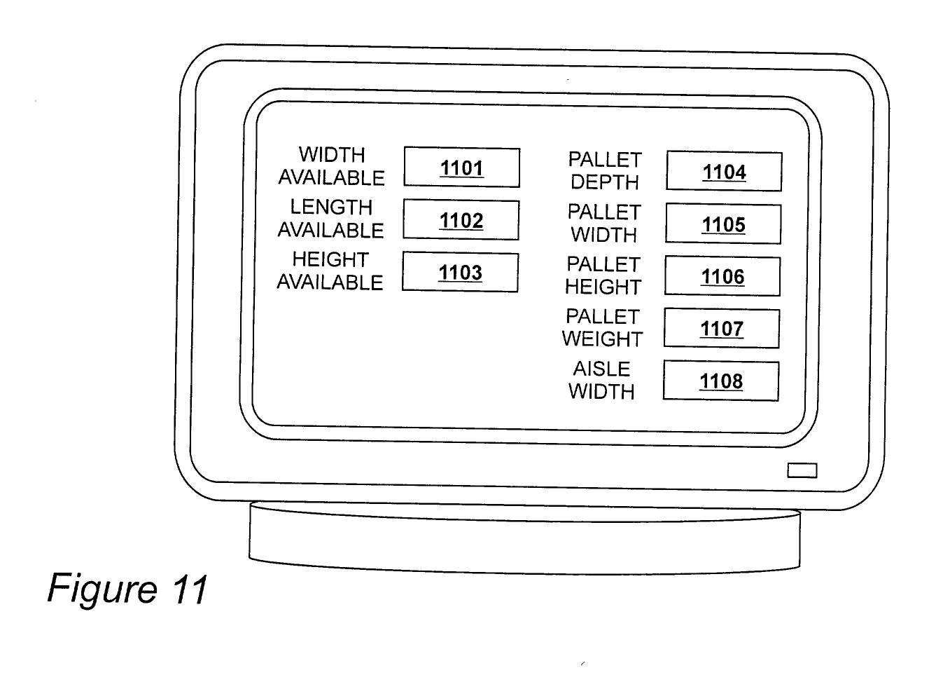

Having specified a brand, a further page is transmitted to the user inviting an input specification, as illustrated in FIG. 11. Having received an input specification in accordance with step 805 the data received at the server is validated. Thus, if any field is left empty a message is returned to the effect that further information is required and the form must be completed in full before the process proceeds to the next stage.

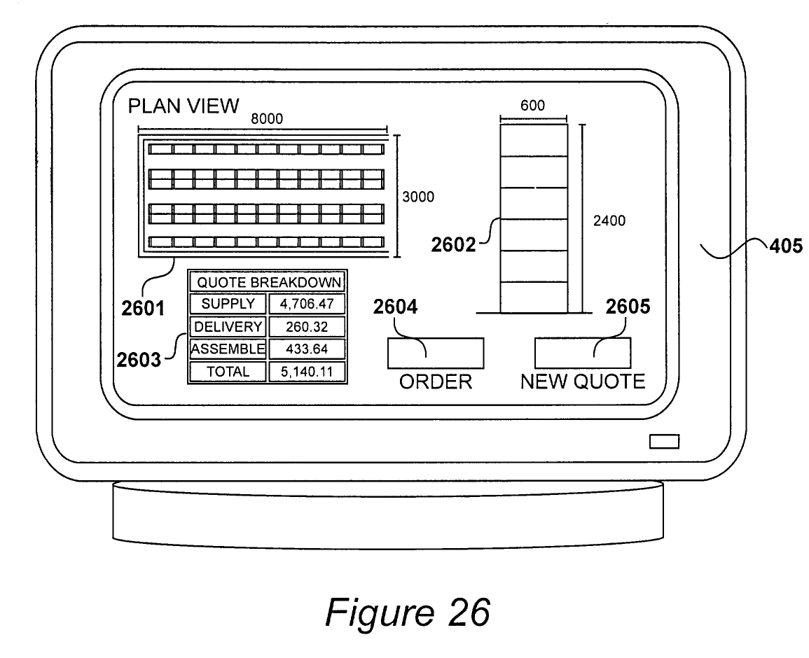

Having validated the data, calculations are performed at step 807 in order to provide a racking solution. Thereafter, having performed the necessary calculations, a graphical representation of the solution is transmitted back to the user at step 80, as detailed in FIG. 26.

As illustrated at step 809, the system may respond to an order placed by the user, resulting in a component order being sent to an originating factory as shown at step 810 whereafter, at step 811 and invoice is sent to the user.

FIG. 9

An identification of an environment type is made in response to receiving a home page as illustrated in FIG. 9. Thus, in response to receiving this page, in the present embodiment, a user may request further information concerning an industrial environment by clicking at 901, an office environment by clicking at 902, a museum and archive environment by clicking at 903, a catering and kitchen environment by clicking at 904, a pallet racking environment by clicking at 905 or a mezzanine floor environment by clicking at 906.

The solution provided by the present preferred embodiment will be developed with reference to pallet racking but it should be appreciated that the techniques and principles may be used in other environments, such as office shelving.

FIG. 10

Having expressed an interest in pallet racking by clicking at 905, a brand type is identified in response to receiving a page as illustrated in FIG. 10. The first racking type is illustrated by a graphical image 1001 and further information concerning this racking type may be selected at 1002. This first racking type may be of a general purpose type allowing random access using conventional forklift trucks. An alternative racking type is illustrated at 1003 and further information may be obtained by clicking at 1004. This may represent a more expensive racking type for use with specialized lifting equipment thereby allowing the racks to be positioned closer together. A third racking type is graphically illustrated at 1005 and further details may be obtained by clicking at 1006. This may, for example, represent high density racking of a first in last-out variety without aisles.

In the present embodiment an interest in racking type A has been established although it should be appreciated that this is purely illustrative and similar techniques may be used for other racking types.

FIG. 11

In response to clicking at 1002 a further page is displayed as illustrated in FIG. 11. The page illustrated in FIG. 11 effectively represents an electronic form suitable for receiving information recorded by the warehouse manager as illustrated in FIG. 3. Thus, at field 1101 the user enters the width (B) of the space available in the warehouse. Similarly, at field 1102 the user identifies the length (A) of the space available in the warehouse and at field 1103 the user identifies the height (C) available in the warehouse.

At field 1104 the user identifies the pallet depth (D); at field 1105 the user identifies the pallet width (W); at field 1106 the user identifies the pallet height (H) and at field 1107 the user identifies the pallet weight (M). At field 1108 an indication of aisle width is made confirming, in this illustrative example, that the aisle width is to be of sufficient size to allow access using conventional forklift equipment.

In alternative embodiments other fields may be included, such as to indicate a customer's reference or location etc. In the preferred embodiment, all customers have previously registered and as such may place orders online. Under alternative embodiments, the system may be configured to provide any inquiry (even to unregistered users) with a racking solution whereafter further commercial arrangements would need to be resolved off line. After entering details in all of the appropriate fields, the completed form is submitted back to the server 502.

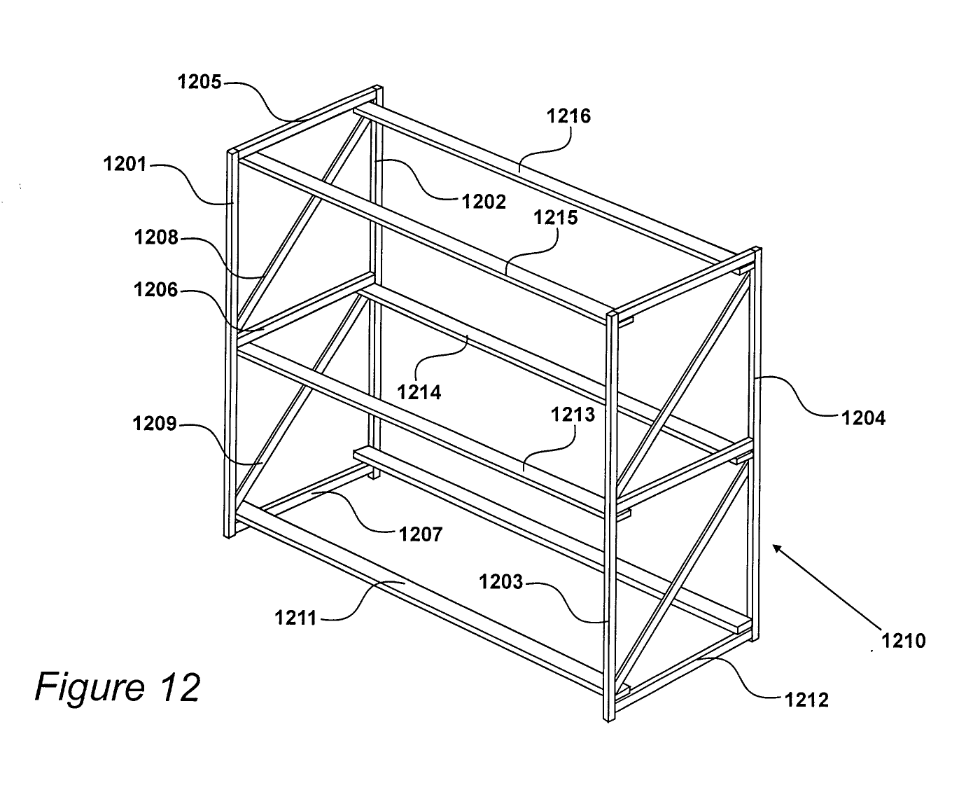

FIG. 12

An example of a design for a pallet racking structure is illustrated in FIG. 12. In this example, racking is constructed from sub-assemblies of the type illustrated in FIG. 12 that are referred to as bays. Each bay has four upright supports 1201, 1202, 1203 and 1204 at its respective corners. Upright support 1201 is assembled with upright support 1202 by horizontal cross members 1205, 1206 and 1207. In additional diagonally cross members 1208 and 1209 are also provided. Thus, in combination upright supports 1201 and 1202 along with cross members 1205 to 1209 provide a support trust. Upright support 1203 and 1204 are also assembled with similar horizontal and diagonal cross members to provide a co-operating upright trust, indicated generally 1210.

Upright support members 1201 to 1204 must support the entire load of the structure. For any particular design, upright supports will be available in a plurality of heights and in a plurality of cross sections, that is to say of a plurality of strengths. Thus, when heavier loads are to be stored on the racking system, upright supports 1201 to 1204 will be required to withstand higher compressive forces. An efficient design therefore needs to optimise the selection of upright supports so as to provide a safe solution for storing the stored units while at the same time not over engineering the solution.

A first horizontal beam 1211 and a second horizontal beam 1212 provide, in combination, a platform for two pallets to be stored thereon. A third horizontal beam 1213 and a fourth horizontal beam 1214 provide a second tier for a similar pair of stored units to be supported. Horizontal beams 1215 and 1216 are not arranged to support a stored unit but are provided to complete the structural integrity of the assembly.

Horizontal beams, such as beams 1213 and 1214 are again provided in a plurality of lengths and of a plurality of cross sections thereby providing beams of various strengths. Higher strength beams will be required as the weight of the stored units increases. Higher strengths may also be required if the width of the bay increases. Thus, again, for a particular storage requirement the horizontal beams must be of sufficient strength to support the weight of the stored units without being over engineered and thereby adding unnecessary cost.

In terms of providing a solution to a customer, individual bay subassemblies are designed based upon the characteristics of the stored unit and the height (C) of the warehouse space. The height of the warehouse space will determine how many tiers may be provided for the bay. With more tiers, the total weight supported by the structure increases therefore this must be taken into account when designing the strength of the upright supports. Thereafter, having engineered an individual bay, a full arrangement of bays is identified with reference to the width and length of the warehouse space. A run of bays is constructed by placing a plurality of bays side by side. This constitutes a single run but given that access is only required from one side, it is possible to place two runs back to back in order to define a double run. Consequently, optimum storage is obtained by designing long runs and then placing as many double runs in the warehouse facility as possible. The space between runs to allow forklift access is referred to as an aisle and the combination of one run, an aisle and a second run may be defined as a module.

Process 807 for calculating a solution includes procedures that produce output results consistent with the design illustrated in FIG. 12. In order for a price to be given to a customer, it is necessary to calculate the totality of components required to provide a solution. Thereafter, the individual price of each component may be identified with reference to a database, allowing these individual values to be added together to provide a final price. Thus, based on the storage requirement, it is necessary to determine the number of upright supports, cross members and horizontal beams and at what strength so that an appropriate order may be generated to complete the job. Furthermore, a graphical representation of the deign is established so that the warehouse manager is quickly provided with a plan view and an elevation view of how the completed structure will appear.

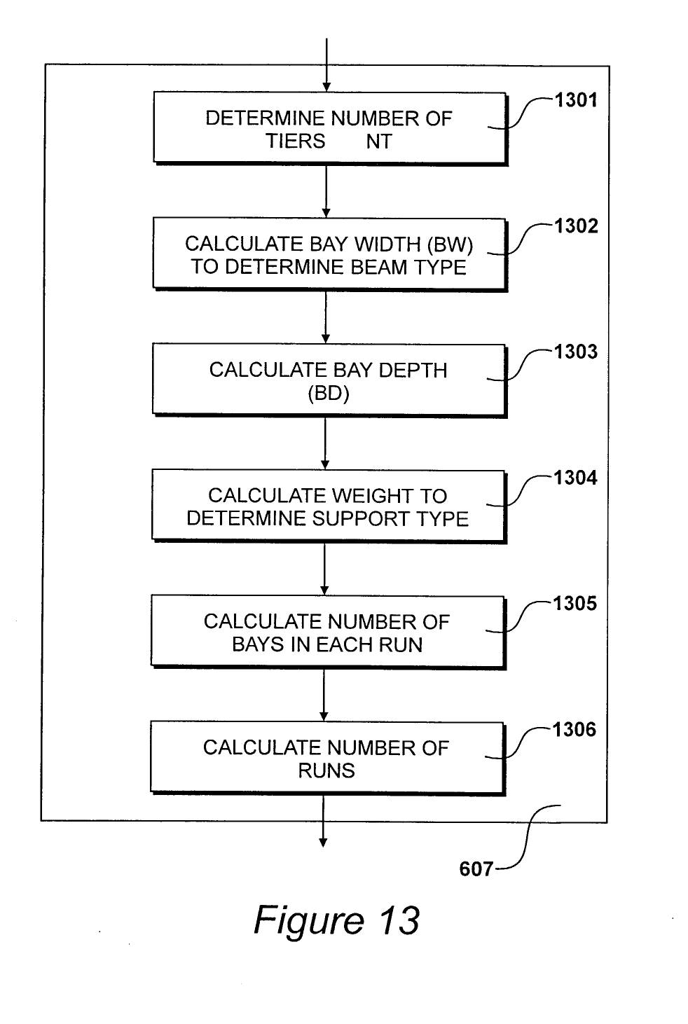

FIG. 13

Procedures 807 for calculating a solution are detailed in FIG. 13. At step 1301 a determination is made (NT) as to the total number of tiers that may be included, usually constrained by the height C of the warehouse space. At step 1302 the bay weight is calculated in order to identify an optimum strength for the upright supports. At step 1303 the bay depth (BD) is calculated and at step 1304 the bay width (BW) is calculated from which it is then possible, in combination with the known total weight applied to each tier, to determine an appropriate beam type.

After step 1304 the bay sub-assembly is completely defined. Consequently, at step 1305 a calculation is made as to the number of bays that may be present in each run. At step 306 a calculation is made to determine the total number of runs that may be placed within the warehouse space.

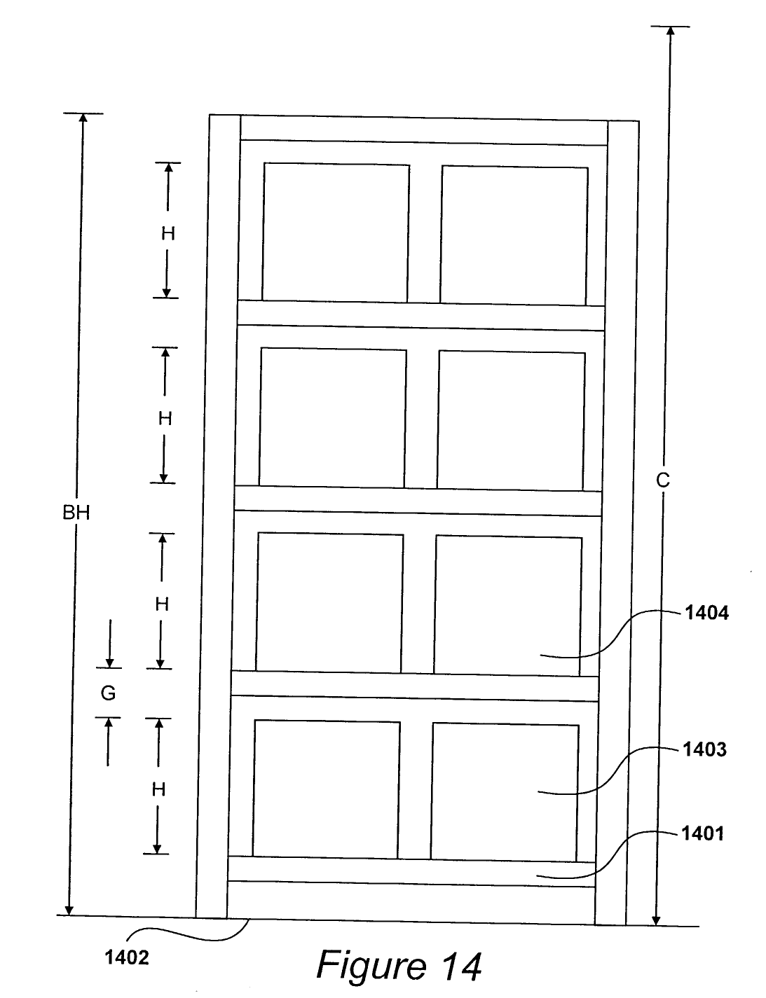

FIG. 14

An example of a result of tier calculation, in accordance with the procedures identified at step 1301, is illustrated in FIG. 14. The warehouse has a working height C and each stored unit has a height H. Consequently, process 1301 needs to determine how many stored units of height H may be stored within the warehouse of height C.

The first support beam 1401 is supported above floor surface 1402 by a distance F. The height H of a stored unit is added to the value of F plus an amount G equal to the distance between the top of a lower unit, such as unit 1403, and the bottom of the next unit 1404. Process 1301 then asks a question as to whether height F plus H plus G is greater than C. If not greater than C, the process is repeated is to determine whether another tier may be included. As shown in FIG. 14, in the example shown it is possible to include four tiers within the height C available. This provides a bay of height BH which, as shown in FIG. 14, is less than the total height C.

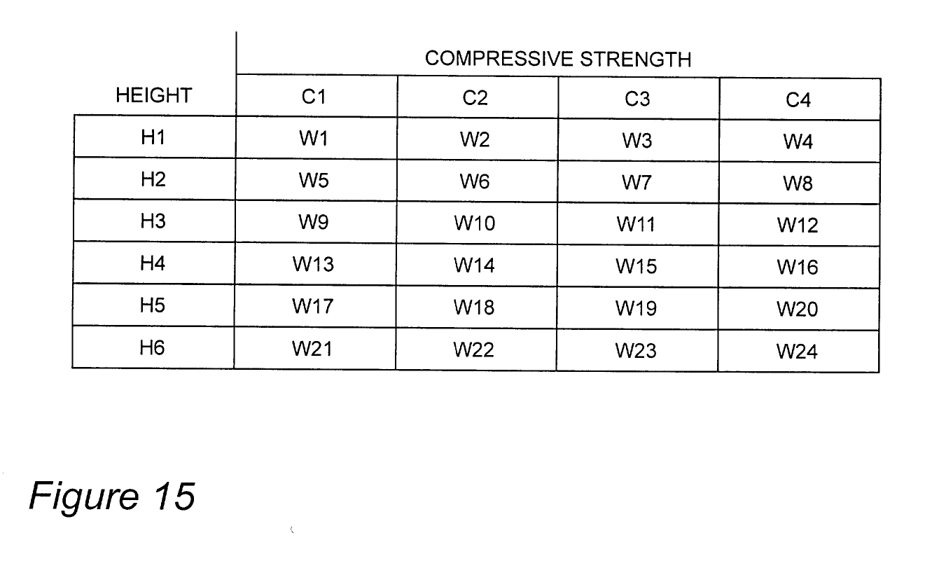

FIG. 15

Database system 601 has many tables for storing information concerning individual components. In order to obtain information from tables contained within database 601, process 1301 issues SQL commands to the database resulting in filtered and ordered query tables being returned that are retained locally as active data objects representing dynamic arrays. An array of this type is illustrated in FIG. 15 in which 6 upright supports have been filtered that are relevant to the particular type of structure being designed. In the array, these upright supports are identified by there height, referenced H1 to H6. For each height of upright support four strength values are available. Given that the topology of the racking structure is fixed, as shown in FIG. 12, weight values stored in the database are appropriately scaled such that an identification of the weight of the stored unit (measured in appropriate units) allows an appropriate upright support to be selected.

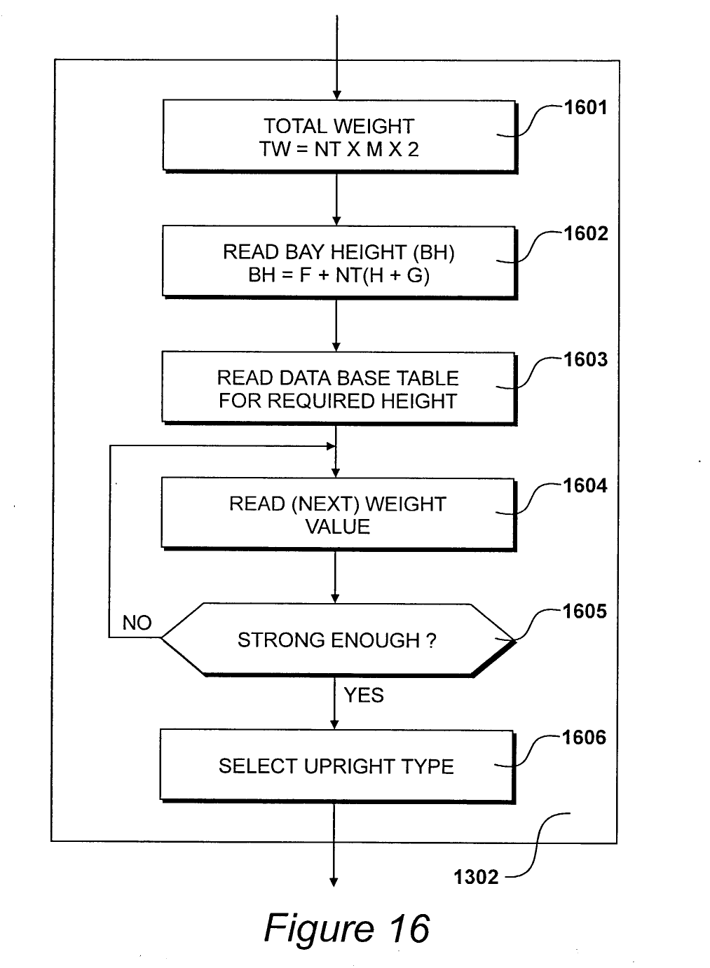

FIG. 16

In this embodiment, weight calculations are based on the total weight supported by each bay. Two units are to be stored on each beam section therefore the total weight is calculated by forming the product of the number of tiers by the mass of each unit multiplied by two. Thus, weight values stored in a database table, such as that illustrated in FIG. 15, are related to the total weight calculated in this manner. However, it should be appreciated that many alternative calculations of this type could be performed provided that the information contained within the database is consistent with the manner of calculation so as to ensure that upright supports are selected that are of optimum strength.

Procedures 1302 for calculating weight to determine support type are detailed in FIG. 16. At step 1601 total weight (TW) is calculated as the product of the number of tiers (NT) by the unit weight (M) multiplied by two. At step 1602 the bay height is read if available or calculated as F plus NT multiplied by the sum of H and G.

At step 1603 the database table is read to identify the required height. Thus, height values H1 to H6 are examined to identify an available upright support having a minimum height of BH and a maximum height of C.

For he purpose of this example, it is assumed that upright H4 is of the optimum height. Having selected support H4, it is now necessary to identify the degree of compressive strength. At step 1604 the first weight value W13 is read and at step 1605 a question is asked as to whether this is strong enough. Thus, if the total weight value calculated at step 1601 is greater than weight value W13 the support is not considered to be strong enough and the question asked at step 1605 will be answered in the negative. On the next iteration the next weight value W14 would be read and the comparison made again. If weight value W14 is greater than the total weight then the optimum upright supports are uniquely defined as being of height H4 and of compressive strength C2. If the question asked at step 1605 continues to be answered in the negative such that, ultimately, upright support C4 does not provide sufficient compressive strength a message to this effect is generated and a customer would be invited to seek further assistance by telephone.

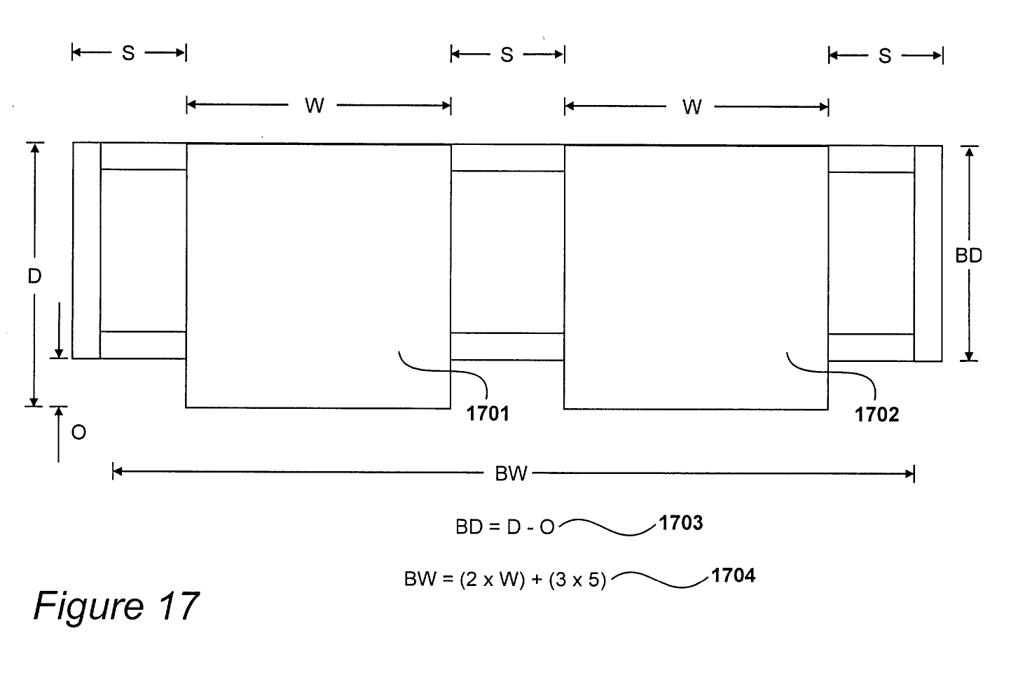

FIG. 17

A plan view of a bay is shown in FIG. 17 supporting two stored units 1701 and 1702. In order to facilitate movement using a forklift truck, each stored unit overhangs its supporting bay by an optimized and safe amount 0. The bay depth BD is therefore less than the depth of the stored unit and is calculated, as shown at 1703, by subtracting the overhang value O from the unit depth D.

Within each bay, space is provided around the sides of the stored units by an optimised amount S. Thus, as illustrated at 1704, the bay width (BW) is calculated by multiplying the unit width W by two and then adding this to the spacing value S multiplied by three.

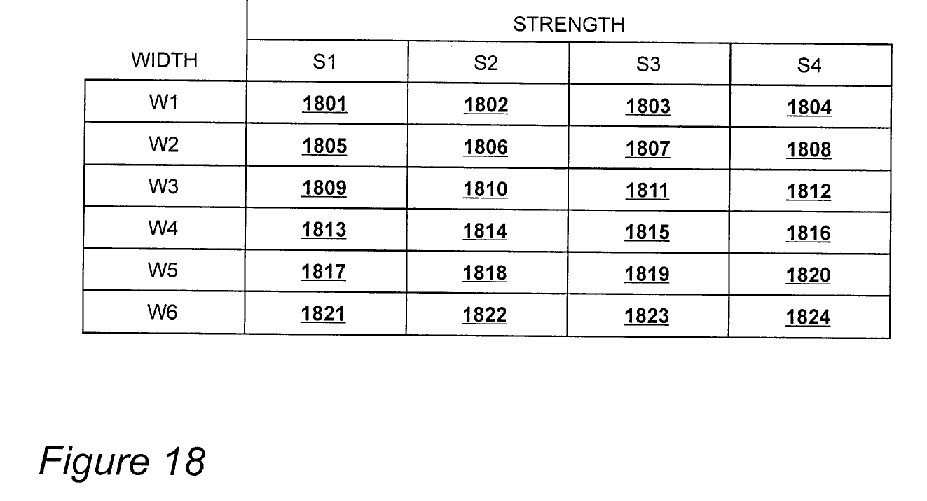

FIG. 18

Database system 601 includes tables for many types of horizontal beams. Having calculated the ideal beam width, as illustrated in FIG. 17, process 1304 identifies an available optimum pair of beams with reference to the ideal beam width and also the required degree of strength.

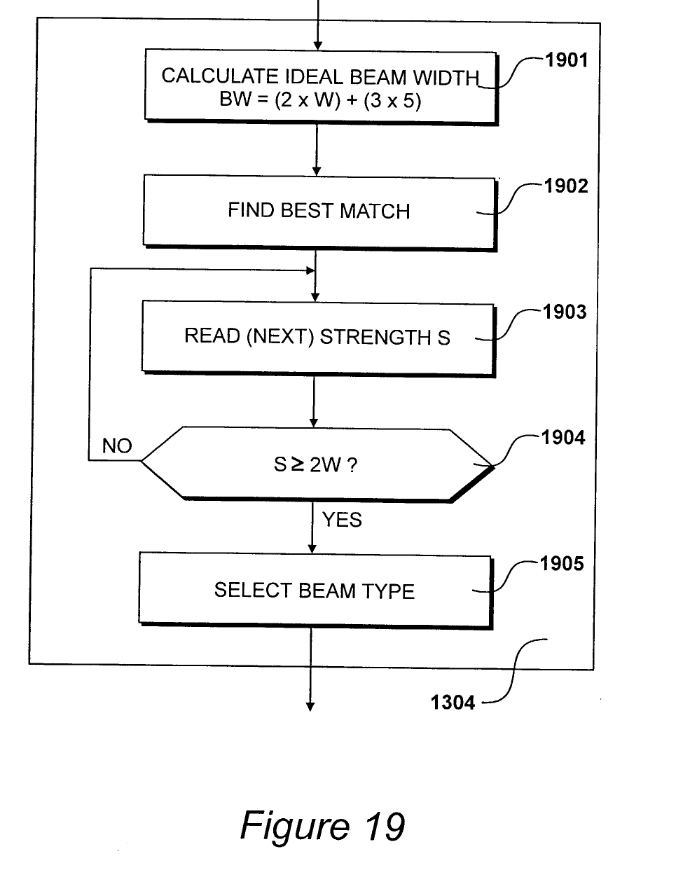

FIG. 19

Procedures for calculating bay width, as identified in FIG. 13, are detailed in FIG. 19. At step 1901 the ideal beam width is calculated using the equation identified at 1704. Thereafter, a query is made to the database 601 to produce an active array of the type illustrated in FIG. 18. The available widths W1 to W6 are considered and process 1902 identifies the best match in terms of the minimum width that is greater than or equal to the ideal beam width BW.

After identifying the optimum width, an optimum strength is selected. At step 1903 a first strength value 1801, 1805, 1809, 1813, 1817 or 1821 is read. At step 2904 a question is asked as to whether the strength value read from the array shown in FIG. 18 is greater than or equal to two times the unit weight W. consequently, the first strength value that satisfies this requirement is selected at step 1905.

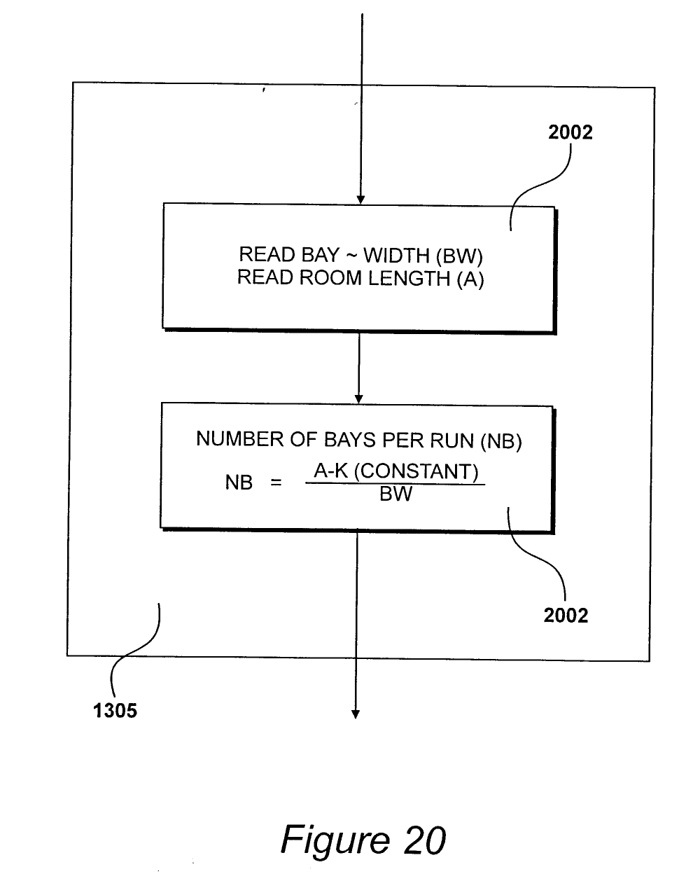

FIG. 20

Process 1305 for calculating the number of bays to be present in each run is detailed in FIG. 20. At step 2001 the bay width BW is read along with the room length (A).

At step 2002 the number of bays per run (NB) is calculated by subtracting a constant tolerance value K from the room length (A) and dividing this by the bay width BW. Any remainder produced may be ignored such that the runs consists entirely of full bays. Alternatively, if the remainder is greater than half a bay width, a half bay may be added.

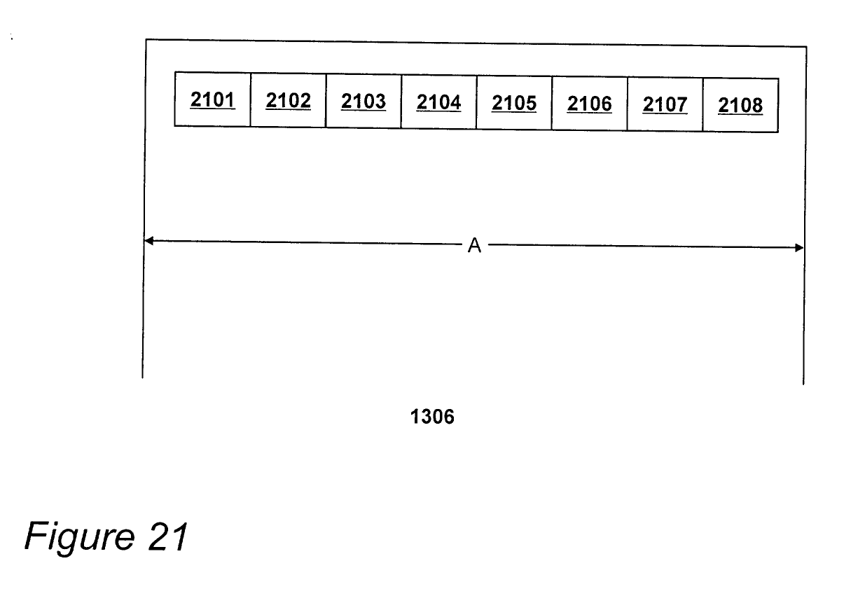

FIG. 21

An illustration of results produced by the process performed by 1305 is illustrated in FIG. 21. In this example, it has been possible to include eight bays 2101 to 2108 within a warehouse interior of length A.

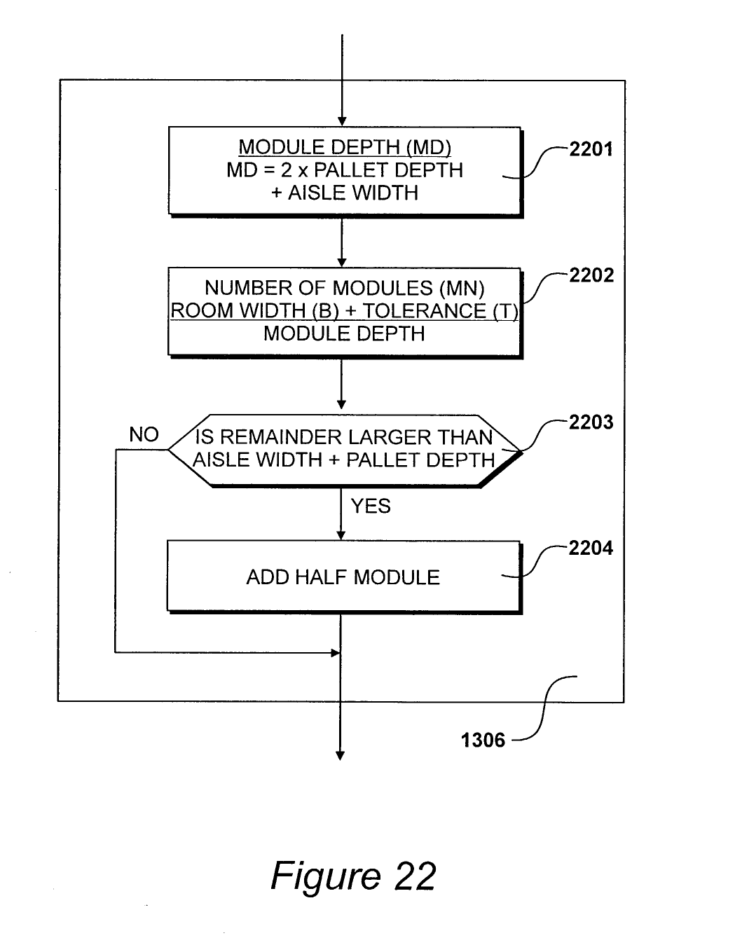

FIG. 22

Process 1306 for calculating the number of runs is detailed in FIG. 22. A module depth (MD) is calculated as being twice the pallet depth (D) plus the aisle width at step 2101.

At step 2102 the number of modules that may be included within the available space is calculated by adding a tolerance value T to the room width B and dividing this by the module depth.

At step 2103 a question is asked as to whether the remainder is larger than an aisle width plus a pallet depth and if this question is answered in the affirmative a half module is added at step 2104.

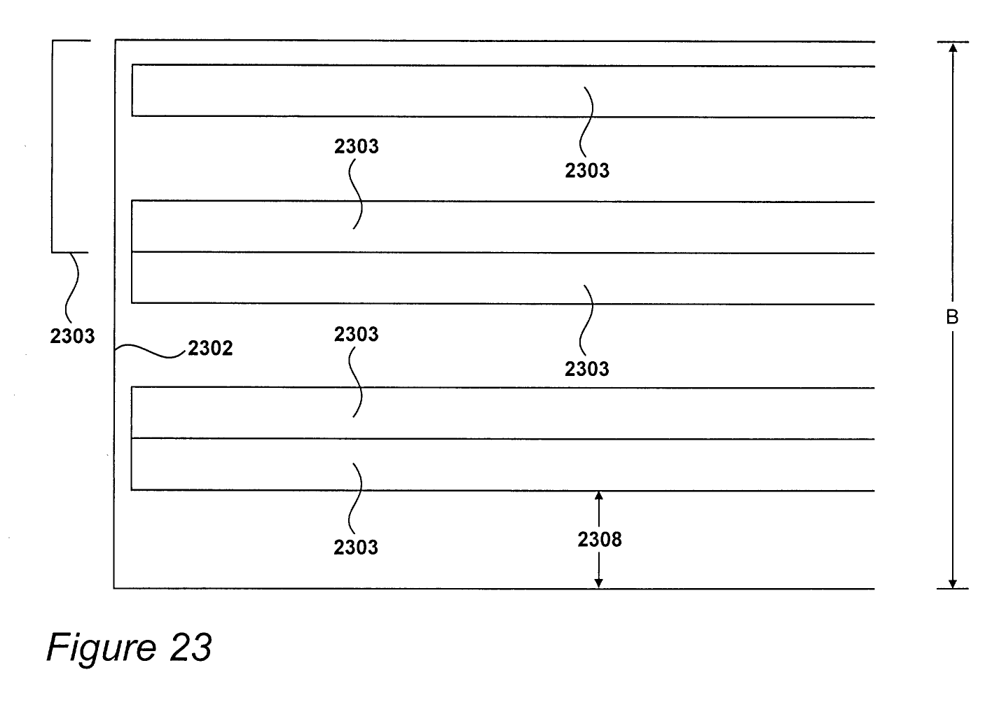

FIG. 23

An example of results obtained by process 1305 is shown in FIG. 23. An assumption is made that a single run 2301 will be placed substantially against a wall 2302 of the warehouse. The first module depth is illustrated at 2303 consisting of the first single run 2301 and one half 2304 of the subsequent double run. Thus, single run 2304 is placed back to back with single run 2305 to produce the double run. In this example, a further iteration results in a double run being established, made up of a single run 2306 placed back to back with single run 2307. On this occasion the remaining space 2308 is not large enough for a further single run to be included.

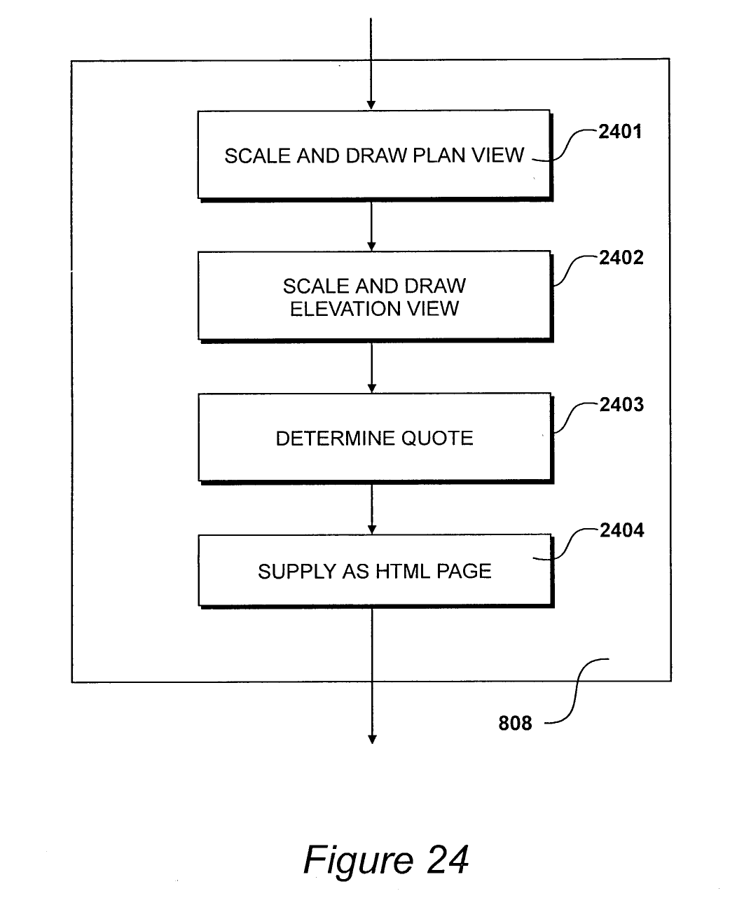

FIG. 24

After completing process 1306 the racking solution has been fully specified such that a graphical solution may be presented to a customer as specified at step 808. Process 808 is detailed in FIG. 24. At step 2401 a plan view is scaled and drawn followed by an elevation view being scaled and drawn step 2402. At step 2403 a quote for the overall system is determined and the information calculated at step 2401 to 2403 is supplied to the customer as an HTML page at step 2404.

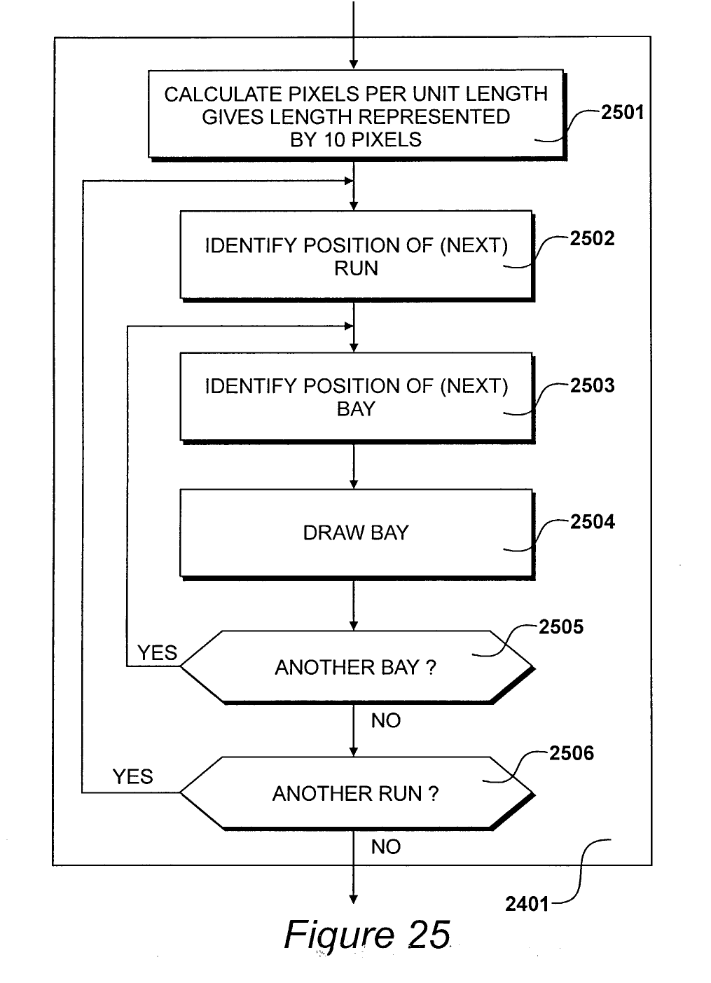

FIG. 25

Process 2401 for scaling and drawing a plan view of the proposed racking solution is detailed in FIG. 25.

At step 2501 the number of pixels of the image present per unit length is calculated. Thus, a calculation is performed to identify what ten pixels of the graphical representation represents in terms of actual lengths of the proposed solution. In a preferred embodiment, a graphical representation of the plan view is produced from a pixel array of 600 by 400 pixels for monitor display. This in turn represents the available floor plan of the warehouse space.

At step 2502 the position of the first run is identified whereafter at step 2503 the position of the first bay of the first run is identified. At step 2504, the first bay is drawn whereafter at step 2505 a question is asked as to whether another bay is present. When answered in the affirmative control is returned to step 2503 resulting in the position of the next bay being identified. Thus, bays continue to be drawn until all of the bays of the run under consideration have been drawn resulting in the question asked at step 2505 being answered in the negative.

At step 2506 a question is asked as to whether another run is to be drawn and when answered in the affirmative control is returned to step 2502. Thus, on the second iteration the position of the next run is identified whereafter iterations of steps 2503 to 2505 result in the individual bays of the run being drawn. Ultimately, all of the bays of all of the runs will be drawn resulting in a question asked at step 2506 being answered in the negative.

A similar process of scaling is performed in order to generate an elevation view showing the tiers of a single bay.

FIG. 26

An HTML page supplied to monitor 405 in accordance with process 2404 is shown in FIG. 26. A plan view 2601, an elevation view 2602 and a quote breakdown 2603 are presented graphically to the user. The quote breakdown identifies a cost of supplying the components, a cost of delivering the components and a cost of installing the complete system along with the total cost for the overall process. A first button 2604 invites the customer to place a firm order. In addition, a second button 2605 allows a customer to request a new quote.

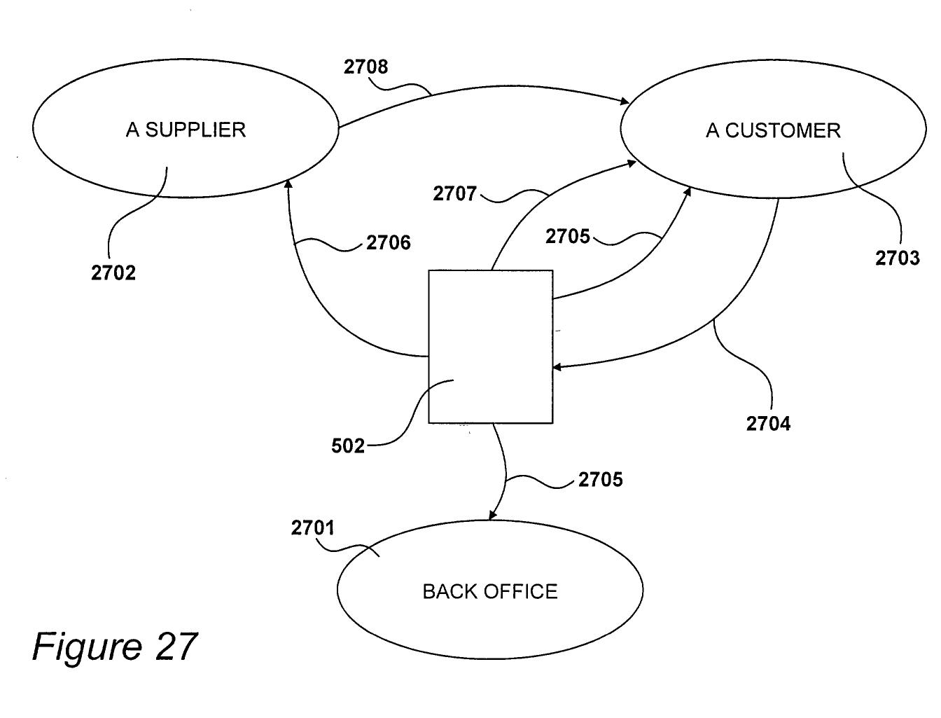

FIG. 27

Operations performed in accordance with process 809, resulting in the system responding to an order being placed by a customer, are illustrated in FIG. 27. The server 502 communicates with a back office facility 2701 in addition to communicating with a plurality of suppliers, such as a supplier 2702 and a plurality of customers such as a customer 2703.

The processes initiated by a customer 2703 requesting a web page from server 502 is illustrated by arrow 2704. Information is then returned back to the customer in the form of a detailed quote with a graphical representation of the solution as illustrated by arrow 2705 after further information relating to the specification has been supplied by the customer. The customer then places a firm order that is interpreted by the server 502. The server 502 notifies the back office to the effect that an order has been placed as illustrated by arrow 2705. In an alternative embodiment the back office staff would then be responsible for placing an order with a supplier and invoicing a customer. However, in the preferred embodiment server 502 automatically generates an order to a supplier 2702 as illustrated by arrow 2706.

Server 502 also transmits an invoice to a customer 2703 as indicated by arrow 2707. The order 2706 and the invoice 2707 could be supplied conventionally on paper. However, preferably, these communications occur electronically by e-mail. Furthermore, in a preferred embodiment the requests are supplied electronically and processed by information technology equipment at a supplier 2702 and/or at a customer 2703.

Preferably without further intervention on the part of server 502 or the back office 2701 a supply of goods is made from a supplier 2702 to a customer 2703 as indicated by arrow 2708.

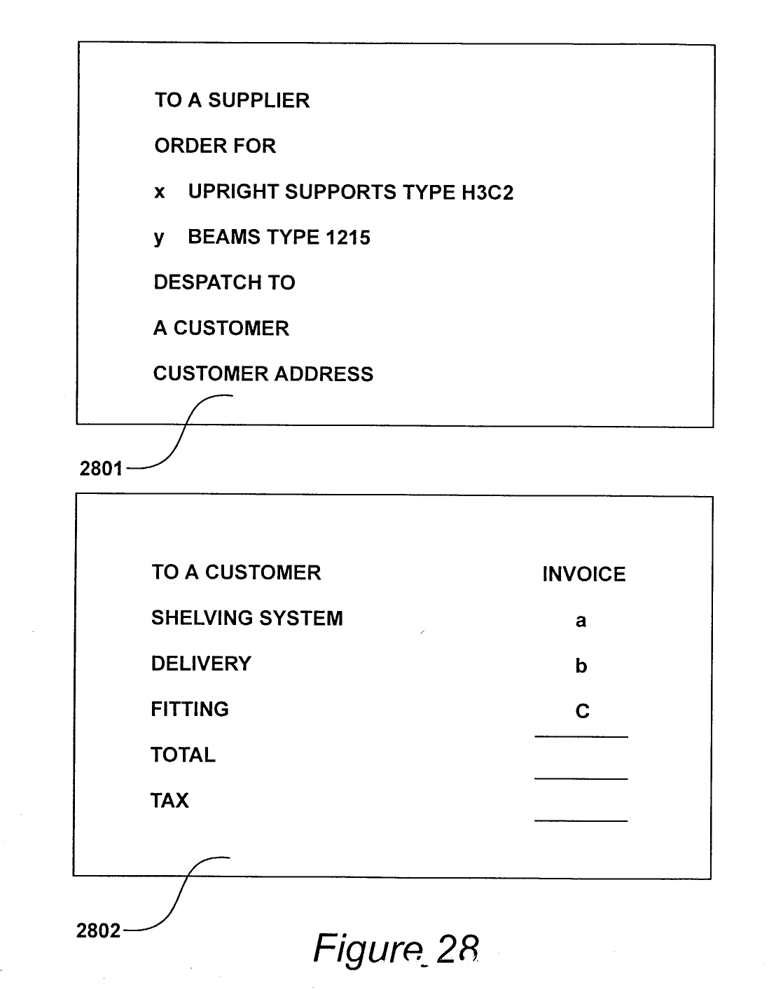

FIG. 28

An example of an order 2801 and an example of an invoice 2802 are shown in FIG. 28.

The order 2801 specifies individual components which, in this example are identified as x upright supports of type H3C2 and y beams of type 1215. In addition, the details of a customer are identified along with the customer's address so as to allow the components to be sent directly to the customer.

Invoice 2802 includes an entry a for the shelving system, an entry b for the delivery and an entry c for the fifting followed by a total amount and, where appropriate, a indication of tax payable.

The solution provided by the preferred embodiment allows a quick and accurate quote to be provided to customers in response to minimal information being supplied via a web page. Database technology allows many difference solution types to be included within the system and the operations performed within the processing environment are such as to ensure that all proposed solutions are safe. Furthermore, safety aspects of solutions are further enhanced by eliminating human error during calculation procedures.

The graphical representation of the solution provided to a customer allows a customer to see how the solution will look when assembled. Graphics of this type may be printed and reference may be made to such prints during discussions within an organisations as part of a decision making process. The amount of effort required on the part of the server is minimal with no further effort being required directly on the part of the supplier. However, the benefit to the customer is significant therefore there is a much greater possibility that an order will be placed. The preferred embodiment has been described with reference to pallet racking but it should be appreciated that similar techniques may be used in related environments, such as shelving.

1. Serving apparatus connected to an inter-network configured to receive requests from remote customers over said inter-network relating to components of storage supporting means, comprising
input means for receiving storage-requirement input data from remote customers;
a database for storing data relating to attributes of components for storage supporting means;
processing means for performing calculations based on data received from customers in combination with data read from said database; and
output means for supplying graphical data to a remote customer, wherein said graphical data is displayed at a customer's terminal in the form of a proposal for a storage solution, wherein
an identification of storage type is received by said input means;
a definition of available storage space is received by said input means;
said processing means calculates a substantially optimum storage configuration;
said processing means generates a graphical representation of said storage configuration; and
said output means supplies said graphical representation of said storage configuration to said customer.

2. Serving apparatus according to claim 1, wherein said storage-requirement input identifies the size of the storage facility and the size and weight of units to be stored.

3. Apparatus according to claim 1, wherein said database stores details of many different storage environments.

4. Apparatus according to claim 3, wherein said database stores details of a plurality of storage types for each of said environments.

5. Apparatus according to claim 1, wherein said calculations performed by said processing means identify structure components of sufficient strength based on weight related calculations.

6. Apparatus according to claim 1, wherein said graphical data shows a plan view and a elevation view.

7. Apparatus according to claim 1, wherein said graphical data is generated by iteratively creating bay-shapes in rows.

8. Apparatus according to claim 7, wherein said graphical data is generated within a predefined pixel grid and a scaling operation is performed to identify the number of pixels present within each bay shape.

9. Apparatus according to claim 1, wherein said output means also provides price-related information.

10. Apparatus according to claim 9, including means for allowing a customer to place an order online.

11. A method of serving data representing storage supporting means solutions in response to request received from remote customers, comprising the steps of:
receiving storage requirement input data from remote customers;
storing data related to attributes of components for storage supporting means;
performing calculations based on data received from customers in combination with data read from said database and
supplying graphical data to remote customer, wherein said graphical data is displayed at a customers terminal in the form of a proposal for a storage solution.

12. A method according to claim 11, wherein said calculations identify structure components of sufficient strength based on weight related calculations.

13. A computer readable medium having computer readable instructions executed by a computer such that, when executing said instructions, a computer will perform steps of:
receiving storage requirement input data from remote customers;
reading data related to attributes of components from a database system;
performing calculations based on data received from said customers in combination with data read from said database; and
supplying graphical data to remote customers, wherein said graphical data is displayed at a customers terminal in the form of a proposal for a storage solution.

14. A computer readable medium having computer readable instructions according to claim 13, such that when executed said instructions a computer will also perform the steps of identifying the size of a storage facility and the size and weight of units to be stored.

15. A computer readable medium having computer readable instructions according to claim 13, such that when executing said instructions a computer will store details of many different storage environments.

16. A computer readable medium having computer readable instructions according to claim 15, such that when executed said instructions a computer will store details of a plurality of storage types for each of said environments.

17. A computer readable medium having computer readable instructions according to claim 13, such that when executing said instructions a computer will also perform the step of presenting graphical data showing a plan view and a elevation view.

18. A computer readable medium having computer readable instructions according to claim 13, such that when executing said instructions a computer will also perform the step of generating said graphical data by iteratively creating a shapes in rows.

19. A computer readable medium having computer readable instructions according to claim 18, such that when executing said instructions a computer will generate said graphical data within a predefined pixel grid after performing a scaling operation to identify the number of pixels within each bay shape.

20. A computer readable medium having computer readable instructions according to claim 13, such that when executing said instructions price related information is provided allowing a customer to place an order online.
